(19) United States
(12) Patent Application Publication
(10) Pub. No.: US 2024/0013801 A1
(43) Pub. Date: Jan. 11, 2024

(54) AUDIO CONTENT SEARCHING IN MULTI-MEDIA

(71) Applicants: Getac Technology Corporation, New Taipei City (TW); WHP Workflow Solutions, Inc., North Charleston, SC (US)

(72) Inventors: Muhammad ADEEL, Edina, MN (US); Thomas GUZIK, Edina, MN (US)

(21) Appl. No.: 17/859,328

(22) Filed: Jul. 7, 2022

(51) Int. Cl. G10L 25/51; G06F 16/632

(52) U.S. Cl. CPC G10L 25/51; G06F 16/632; H04L 65/61

(57) ABSTRACT

Techniques for audio content searching in multi-media content are described. Such techniques may be utilized to enhance investigator productivity while reviewing captured multi-media content, in particular, audio and video evidence captured during an incident. ML models may be trained to identify audio content portions and automatically generate metadata tags. ML models may be trained to track audio with a set of characteristics throughout a set of multi-media content items. ML models may be trained, and captured multi-media content may be processed centrally, for example, at a network operations center (NOC). Alternatively, or in addition, at least some model training and/or content processing may be performed at the network's edge, for example, performed by a content capturing device such as a body-worn camera and/or at a capture-local communications hub such as an in-vehicle computer of a law enforcement vehicle.

### BACKGROUND

Law enforcement agencies provide officers and agents with an assortment of devices—electronic and otherwise—to carry out duties required of a law enforcement officer. Such devices include radios (in-vehicle and portable), body-worn cameras, weapons (guns, Tasers, clubs, etc.), portable computers, and the like. In addition, vehicles such as cars, motorcycles, and bicycles, may be equipped with electronic devices associated with the vehicle, such as vehicle cameras, sirens, beacon lights, spotlights, and personal computers.

It is increasingly common for law enforcement agencies to require officers to activate cameras (body-worn and vehicle-mounted) that enable officers to capture audio and/or video contents of incidents in which an officer is involved. This provides a way to preserve evidence, that would otherwise be unavailable, for subsequent legal proceedings. This evidence greatly aids in the investigation of criminal activities, identification of perpetrators of crimes, and an examination of allegations of police misconduct, to name a few advantages.

It is also desirable to further investigate the incidents based on the captured audio and/or video content. However, as the amount of captured content becomes large, investigation times can become lengthy and there is a growing need for investigation productivity tools.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture that implements a multi-media content identifier to tag and associate searchable content to telemetry data streams with an event streaming platform in accordance with at least one embodiment.

FIG. 2 is a block diagram of an example implementation of the multi-media content identifier that is configured to execute one or more sub-models to infer a safety of a law enforcement officer during a dispatch event and facilitate a tagging and associating of the searchable content to the telemetry data streams, in accordance with at least one embodiment.

FIG. 3 is a block diagram of a NOC server that implements the tagging and associating of the searchable content to the telemetry data streams, in accordance with at least one embodiment.

FIG. 4 is a block diagram of an example data table showing sub-models and corresponding attributes that can be used in a machine-learning algorithm to implement the tagging and associating of the searchable content to the telemetry data streams, in accordance with at least one embodiment.

FIG. 5 is a flow diagram of an example procedure for implementing the tagging and associating of the searchable content to the telemetry data streams, in accordance with at least one embodiment.

FIG. 6 is a flow diagram of an example procedure for aggregation of sub-model outputs to infer an output such as the safety of the law enforcement officer during the dispatch event, in accordance with at least one embodiment.

### DETAILED DESCRIPTION

This disclosure is directed to techniques for audio content searching in multi-media content. Such techniques may be utilized to enhance investigator productivity while reviewing captured multi-media content, in particular, audio and video evidence captured during an incident. Machine learning (ML) models may be trained to identify audio content portions (e.g., a horn blaring, a dog barking, a gunshot, a specific utterance such as “Officer down!”) and automatically generate metadata tags. Alternatively, or in addition, ML models may be trained to track audio with a set of characteristics throughout a set of multi-media content items. For example, a portion of audio may be identified as the voice of a law enforcement officer or an incident participant, and one or more ML models may be trained to identify other portions of the set of content items which also includes the voice. The tracked “audio object” need not be a voice and may include any suitable set of trackable characteristics. ML models may be trained, and captured multi-media content may be processed centrally, for example, at a network operations center (NOC). Alternatively, or in addition, at least some model training and/or content processing may be performed at the network's edge, for example, performed by a content capturing device such as a body-worn camera and/or at a capture-local communications hub such as an in-vehicle computer of a law enforcement vehicle. In a network environment where content can be generated from multiple different devices at potentially different locations and times, maintaining consistent and reliable identification of audio objects can enhance investigator productivity.

In accordance with at least one embodiment, training and execution of sub-models of a data model (e.g., a ML model) may be utilized to identify instances of searchable content in telemetry data streams (e.g., multi-media content streams and associated metadata streams). The data model may include logical sub-models that can be used to identify audio content features such as a gunshot, vehicle sound, distressed sound, and human reaction sound. The sub-models may also be used to identify video content features such as a position of a person holding an object during a dispatch event, bright spots associated with the object during the dispatch event, and so on. The output of these sub-models may be aggregated to generate an output of the data model, which can be used, for example, to infer a level of safety of the law enforcement officer during the dispatch event.

In accordance with at least one embodiment, the identified audio content features may be associated with corresponding searchable content (e.g., audio objects) to improve processing of large multi-media content data from heterogeneous sources (e.g., different types of media recording devices). Searchable content may include a phrase (e.g., “officer down”), object (e.g., gun drawn), or a human reaction (e.g., shouting). The telemetry data streams may include data packet streams of audio content, video content, metadata, virtual reality or augmented reality data, and/or other information that can be encoded in JavaScript Object Notation (JSON), Extensible Markup Language (XML), or other structured data modeling language. The telemetry data streams from the heterogeneous sources may be pushed into an event streaming platform such as APACHE® KAFKA®, and the telemetry data streams can be decoupled and stored in telemetry data storage without losing control of continuity of the telemetry data streams in the event streaming platform. In accordance with at least one embodiment, decoupling of data streams may include generating independent data streams based on one or more raw and/or source data streams of media such as audio and video as well as data streams of events. For example, a single event data stream may be associated with multiple media data streams, and independent telemetry data streams may be generated from the raw and/or source data streams at least in part by combining each media data stream with the associated event data stream. The sub-models may be trained on the decoupled and stored telemetry data streams, and output of each of the sub-models can be tagged and associated with corresponding searchable content that can be used for law enforcement operations, evidentiary matters, and other purposes.

For example, a gunshot that is inaudible or indistinguishable to a human ear may be detected via a trained sub-model that is used to identify presence of the gunshot. In this case, the identified gunshot in the telemetry data streams may be tagged and associated with searchable content (e.g., a portion of the audio may be tagged as “gunshot”) for future reference or processing. In another example, a different sub-model may be trained to detect a distress sound such as a cry of “HELP” or a sound of car tires screeching. In this other example, the identified distress moments in the telemetry data streams may be tagged and associated with searchable content (e.g., a victim in distress or a suspect resisting) to facilitate improved multi-media content searching and identification. In these examples, the techniques described herein may be implemented for many purposes, including but not limited to inferring a law enforcement officer's safety, and further to provide reliable identification of data streams via tagging of particular events.

In accordance with at least one embodiment, the sub-models may be executed in parallel among different cores of a network operating center (NOC) server or on different network resources that can be connected to the NOC server including computational resources residing at the network edge. Further, the output of the sub-models may be combined to provide an aggregate set of result data such as, for example, inferring the safety level of the law enforcement officer during the dispatch event. Since the output of each sub-model may contribute to a larger, parent data model, each sub-model can be computationally less complex (e.g., may have fewer data dimensions). Different searchable content may be associated with the output of the various sub-models as well as output(s) of the parent data model. The sub-models may contribute to the parent data model utilizing any suitable algorithmic technique including linear combination to create a rank and/or score such as a likelihood, and/or acting as an input to a ML model that is trained for the parent data model. In accordance with at least one embodiment of the invention, there may be multiple parent data models that receive input from some subset of the sub-models (e.g., distinct subsets) and which output data corresponding to one or more detected events and/or conditions.

In accordance with at least one embodiment, an output of a first sub-model may be utilized to facilitate monitoring of searchable audio content while an output of a second sub-model can be utilized to monitor searchable video content in the telemetry data streams. The searchable audio and video contents may be associated with different timestamps, different media recording device identifications (IDs), audio or video descriptions, and other similar information. Following the execution of the first and second sub-models, the result data of a selected subset of sub-models may be aggregated to create aggregated result data that are representative of the parent data model and/or are utilized as input to the parent data model.

The term “data model” as used herein describes a representation of data, relationships between data, and/or constraints of data needed to support requirements. The requirements, for example, set by a data model administrator, form the basis of establishing intra-relationships within the data and drawing inferences from the data. The term “model attributes,” as used herein, describes features of the data model and/or characteristics of entity types represented within the data model. For example, entity types may correspond to gunshots, celebratory events, distressing moments, and/or individuals, objects, or concepts that are represented within a data model. For example, consider a data model used to infer a safety of a law enforcement officer during a dispatch event. In this example, a domestic violence call (dispatch event), gunshot sounds, conversational sounds, scuffling sounds, and shouting certain phrases such as “DON'T MOVE,” each qualify as entity types that can be detected by corresponding sub-models and thereafter combined to infer, for example, the safety level of the law enforcement officer during the dispatch event. A categorization (e.g., extreme danger) of the sub-model outputs can be transmitted in real-time to surrounding officers. Further, the telemetry data streams associated with the detected events may be tagged as searchable content for future reference or processing.

As used herein, the terms “device,” “portable device,” “electronic device,” and “portable electronic device” are used to indicate similar items and may be used interchangeably without affecting the meaning of the context in which they are used. Further, although the terms are used herein in relation to devices associated with law enforcement, it is noted that the subject matter described herein may be applied in other contexts as well, such as in a security system that utilizes multiple cameras and other devices.

Some implementations and operations described herein may be ascribed to the use of a server; however, alternative implementations may execute certain operations in conjunction with or wholly within a different element or component of the system(s). In particular, in accordance with at least one embodiment, server functionality may be distributed across multiple computing devices including devices that do not primarily and/or typically act in the role of servers such as network edge devices. Further, some of the techniques described herein may be implemented in a number of contexts, and several example implementations and context are provided with reference to the figures. The term “techniques,” as used herein, may refer to system(s), method(s), computer-readable instruction(s), module(s), algorithms, hardware logic, and/or operation(s) as permitted by the context described above and throughout the document.

### Example Architecture

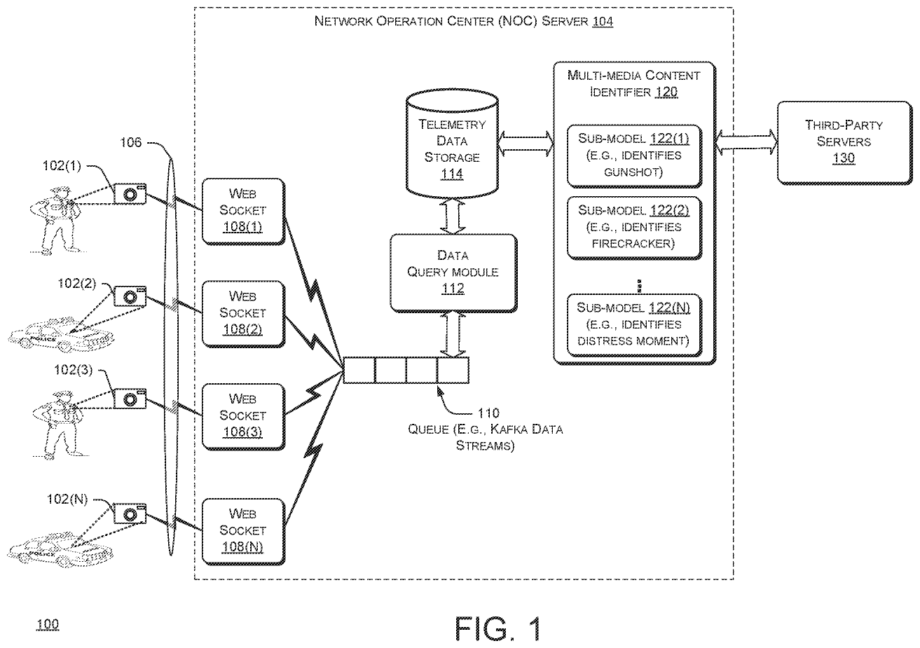

FIG. 1 illustrates a schematic view of an example computing architecture 100 that implements a multi-media content identifier to tag and associate searchable content to telemetry data streams. In accordance with at least one embodiment, one or more sub-models 122(1)-122(N) may be trained on telemetry data streams to identify different features of audio content such as a gunshot, screeching vehicle, distress sound, or other sounds. The training can be performed at a set time period (e.g., once per day, once per hour, once every 5 minutes, etc.) or as triggered. Training and/or retraining actions may be triggered by a selected subset of audio content types for which rapid and/or timely retraining can enhance detection accuracy. For example, gunshots may be sufficiently well characterized that periodic retraining is sufficient whereas detecting the voice of a newly identified incident suspect may benefit from “as soon as possible” retraining. Each of the identified audio content features may be associated with corresponding searchable content to improve processing of large multi-media data from heterogeneous sources (e.g., different types of media recording devices). The content identifier 120 may access the one or more sub-models from its database, third-party servers 130, or a combination of both. By tagging and associating searchable content to the telemetry data streams, the content identifier 120 may facilitate efficient searching of phrases, sounds, individuals, and/or objects in audio content. Such efficient searching can enhance investigative productivity as well as the productivity of related activities such as resulting court activities including evidence preparation and presentation. Tagging of audio content portions can incorporate features that enable efficient evidence provenance determination including content and content portion fingerprinting and/or cryptographic signing based on device identifiers, officer identifiers, location data, timestamps and any suitable evidence provenance data.

As shown, the computing architecture 100 may include media recording devices 102(1)-102(N) (sometimes referred to as user devices) of different types. The media recording devices 102(1)-102(N) may be connected to a NOC server 104 through a network 106. The NOC server 104 may be part of a facility that is operated by a law enforcement agency or a facility that is operated by a third-party that is offering services to the law enforcement agency. The NOC server 104 may implement web sockets 108(1)-108(N), a receiving queue 110, a data query module 112, telemetry data storage 114, and a multi-media content identifier 120 that includes one or more sub-models 122(1)-122(N) of a data model (not shown). The multi-media content identifier 120 may be communicatively connected to a third-party server(s) 130 that can provide additional sub-models to identify the audio and/or video content in the telemetry data streams and/or help in parallel processing of the sub-models that can be trained to the telemetry data streams to identify and tag audio and/or video content. Each component or module of the NOC server 104 can be realized in hardware, software, or a combination thereof. For example, the web-sockets 108(1)-108(N) may be implemented by a software module designed to establish communications with the media recording devices 102(1)-102(N), respectively.

Each of the media recording devices 102(1)-102(N) may be a video recording device, an audio recording device, or a multimedia recording device that records both video and audio data. The media recording devices 102(1)-102(N) may include recording devices that are worn on the bodies of law enforcement officers, and/or recording devices that are attached to the equipment, e.g., motor vehicles, personal transporters, bicycles, etc., used by the law enforcement officers. For example, a law enforcement officer that is on foot patrol may be wearing the media recording device 102(1). In another example, a patrol vehicle of the law enforcement officer may be equipped with the media recording device 102(2). In another location or jurisdiction, another law enforcement officer is wearing the media recording device 102(3), and so on. In these examples, each of the media recording devices 102 may transmit captured audio and/or video data to the NOC server 104 via the network 106. Further, each of the media recording devices 102 may send their respective information such as device ID, name of the law enforcement officer, type of dispatch event, and other similar information.

The network 106 may be, without limitation, a local area network (“LAN”), a larger network such as a wide area network (“WAN”), a carrier network, or a collection of networks, such as the Internet. Protocols for network communication, such as TCP/IP, may be used to implement the network 106. The network 106 may provide telecommunication and data communication in accordance with one or more technical standards. While the third-party server(s) 130 are not shown to connect through the network 106, the NOC server 104 may access the third-party servers via the network 106 or other communication mediums.

Each one of the web-sockets 108(1)-108(N) may include an endpoint of a two-way communication link between two programs running on the network 106. The endpoint includes an Internet Protocol (IP) address and a port number that can function as a destination address of the web-socket. Each one of the web-sockets 108(1)-108(N) is bound to the IP address and the port number to enable entities such as the corresponding media recording device(s) to communicate with the web socket. In one example, the web-sockets 108(1)-108(N) may be set up to receive telemetry data streams from the media recording devices 102(1)-102(N), respectively. Different data streams from different media recording devices may be identified by the corresponding device IDs and other device information of the capturing media recording devices. The received telemetry data streams may be pushed to the queue 110 before they are decoupled, via the data query module 112, and stored in the telemetry data storage 114.

In one example, the decoupled telemetry data streams may include the data streams that the telemetry data storage 114 subscribed to receive via a publish/subscribe mechanism of the queue 110 (e.g., as provided by APACHE® KAFKA®). For example, the decoupled telemetry data streams may include audio content for a particular dispatch event at a specific subject, location, and time period. In this example, the telemetry data storage 114 may receive the telemetry data streams that it subscribed to receive. The decoupled telemetry data streams may also be initially transformed to conform with a schema structure (not shown) in the telemetry data storage 114. The schema structure may include data fields that support sensor formats of the media recording devices 102(1)-102(N). As described herein, the decoupling of the telemetry data streams may include independently retrieving and processing the data streams without affecting the continuity or configuration of the telemetry data streams that may be continuously received from the media recording devices 102(1)-102(N).

The queue 110 may include management software that processes telemetry data streams to or from the web-sockets 108. The queue 110 may be implemented by an event streaming platform that supports a publish-subscribe based durable messaging system. The event streaming platform may receive telemetry data streams and store the received telemetry data streams as topics. A topic may include an ordered collection of events that are stored in a durable manner. The topic may be divided into a number of partitions that can store these events in an unchangeable sequence. In this case, the event streaming platform may receive the telemetry data streams, store these telemetry data streams as topics, and different applications may subscribe to receive these topics in the event streaming platform. For example, the telemetry data storage 114 may subscribe to receive the telemetry data streams (topics) for particular types of dispatch events such as a domestic quarrel, traffic violation, or the like. The type of dispatch event may be based upon an entry of the dispatch event in the NOC server 104. In this example, the decoupled telemetry data streams may include the type of dispatch event and associated device ID, timestamps, a header, and other information that can be used to gather application logs, and/or investigate incidents in case of law enforcement operations.

The multi-media content identifier 120 may include an application that may perform the identification, tagging, associating of the searchable content, and/or management of the decoupled telemetry data streams from the queue 110 that are stored in the telemetry data storage 114. In one example, the decoupling of the telemetry data streams may include independently retrieving and processing the data streams without affecting the configuration of the source such as the queue 110. In this example, the multi-media content identifier 120 may perform the identification and tagging of the stored telemetry data streams independent of the continuous transmission of the telemetry data streams from the media recording devices 102.

With stored telemetry data streams in the telemetry data storage 114, the multi-media content identifier 120 may be configured to train in parallel one or more sub-models 122 over the stored telemetry data streams to identify audio contents that are can be tagged for real-time use and/or future references. For example, audio contents such as gunshots, tires screeching, firecracker sounds, scuffling sounds, and the like may be detected via the training of the correspond sub-models on the stored telemetry data streams. In this example, an output of the sub-model may be compared to a threshold value to detect the likelihood of the sound and then subsequently tagged or marked for processing or references. The tagged telemetry data streams may be associated with the device ID of the media recording device 102 that is the source of the multi-media content, timestamps of the dispatch event, and a header such as flags and data length.

In accordance with at least one embodiment, each of the sub-models 122(1)-122(N) may include machine-learning algorithms to infer presence of a particular sound, event, object, or reaction in the processed telemetry data streams. The sub-model, for example, may correlate input telemetry data streams with data points of the sub-model to infer a likely presence of the corresponding sound, event, object, or reaction. In one instance, the input data or data attributes for the gunshot may include type of dispatch event such as attending to a robbery report or domestic violence. The data attributes may also include time of day, volume of detected sound, detection of phrases such as “SHOTS FIRED” or “OFFICER DOWN,” and the like. In this instance, the sub-model such as the sub-model 122(1) that identifies the presence of the gunshot sound may generate an above threshold output to infer the likely presence of the gunshot sound. In another instance, the input data or data attributes for the firecracker sound may include a time of the year such as the week of the fourth of July holiday when firecrackers are commonly used, frequency of different spikes in sounds, presence of regular conversation or laughter, and the like. In this other instance, the sub-model such as the sub-model 122(2) that identifies the presence of the firecracker sound may generate an above-threshold output to infer the likely presence of the firecracker sound, and so on.

In one instance, the sub-models 122(1)-122(N) may be aggregated to form a data model based on the underlying model attributes of the data model. For example, the data model may be used to infer the safety of the law enforcement officer during the dispatch event. In this example, each output of the sub-models may be used as an attribute to categorize the dispatch event rather than identifying only the audio contents for purposes of tagging and associating searchable contents as described herein. Consider, for example, the sub-model outputs that can include a detection of a gunshot sound during a domestic violence call (dispatch event), scuffling sounds, and shouting certain phrases such as “DON'T MOVE.” In this example, each output may qualify as entity type that can be combined to categorize the data model, which infers the safety of the law enforcement officer during the dispatch event. This categorization (e.g., extreme danger) can be transmitted in real-time to surrounding officers.

In accordance with at least one embodiment, the multi-media content identifier 120 may import the sub-models from another entity such as the third-party server(s) 130. Here, the multi-media content identifier 120 may interact with the third-party server(s) 130 via the network 106, for example, to retrieve the sub-models suited for various analyses. In the context of law enforcement activity, an operator of the NOC server 104 may owe a duty of care to the law enforcement officer and utilization of the data model to infer a safety level of the law enforcement officer during the dispatch event may assist in fulfilling that duty.

### Example Processing of Telemetry Data Streams

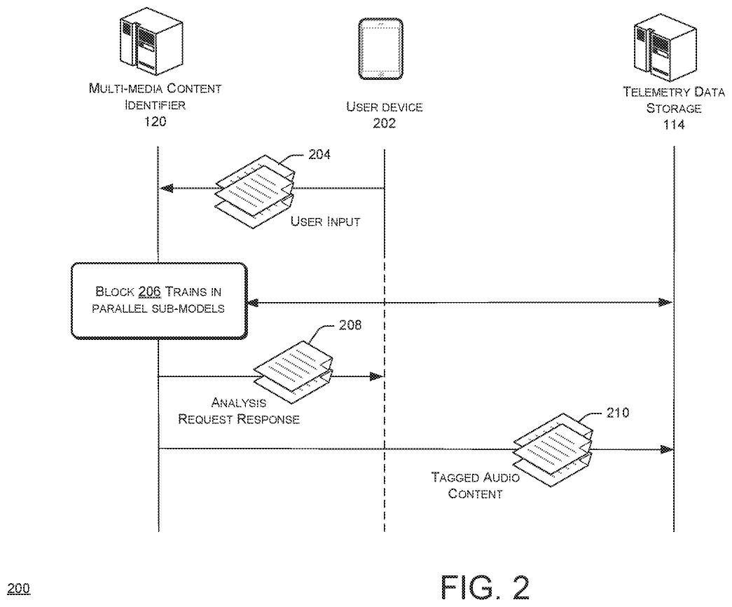

FIG. 2 illustrates a swim lane diagram 200 for an example multi-media content identifier 120 that is configured to receive a user input from a user device 202 and selectively execute sub-models to generate an analysis request response such as inferring a safety level of a law enforcement officer during a dispatch event. In the illustrated example, the multi-media content identifier 120 may receive a user input 204 from the user device 202, which may, for example, correspond to the media recording device 102 in FIG. 1. The user input 204 may include environmental data and an analysis request. The environmental data may include real-time audio data, visual data, or a combination thereof. The analysis request may denote an intent of the analysis, such as inferring a safety of attending law enforcement officers during a dispatch event.

The multi-media content identifier 120 may use the analysis request of the user input 204 to select a data model, which can be further formed by aggregated sub-models. In this case, the data model may be used to analyze the environmental data associated with the user input 204. In some examples, the multi-media content identifier 120 may analyze the environmental data to identify input attributes, which indicates a dimensionality of the environmental data. Also, the multi-media content identifier 120 may analyze the data model to identify model attributes, which indicates a dimensionality of the data model.

At block 206, the multi-media content identifier 120 may analyze the model attributes, identify the model attributes of corresponding sub-models, and in doing so, can selectively execute the sub-models to identify the presence of a gunshot, distressed sound, firecracker, scuffling, human reactions, distinct sounds after detection of a particular phrase such as “DO NOT MOVE”—phrase, or a combination thereof. In the illustrated example, the multi-media content identifier 120 may process the decoupled data streams (not shown) from the telemetry data storage 114. The stored telemetry data streams may include the environmental data captured by the user device 102 and subscribed to receive by the telemetry data storage 114. At times, the multi-media content identifier 120 may train and/or retrain in parallel the sub-models to identify the desired audio contents to be tagged and associated with corresponding searchable contents. The searchable contents, for example, may include phrases, objects, the sound of an object, reactions, or other items that may be used to mark data streams for future references.

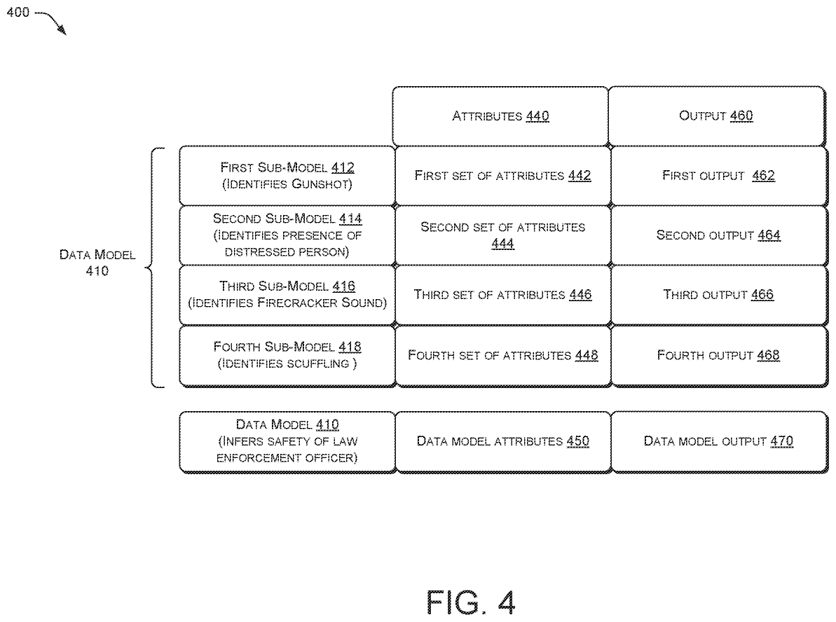

Upon execution of the selected sub-models, the multi-media content identifier 120 may aggregate the sub-model results and use a separate ML model that aggregates sub-model results to generate the analysis request response 208. Further, in response to detection of the gunshot, shouting, and the like, the multi-media content identifier 120 may associate corresponding searchable contents to the telemetry data streams, which, as shown, can be represented by the tagged audio content 210. For example, a first searchable content (“gunshot”) may be associated with a portion of the telemetry data streams that were detected to include gunshot audio sound. In another example, a second searchable content (“distressed moments”) may be associated with a portion of the telemetry data streams that were detected to include shouting and particular words such as “HELP,” and so on. Detailed description of the data attributes for sub-models are further described with reference to FIG. 4.

### Example NOC Server

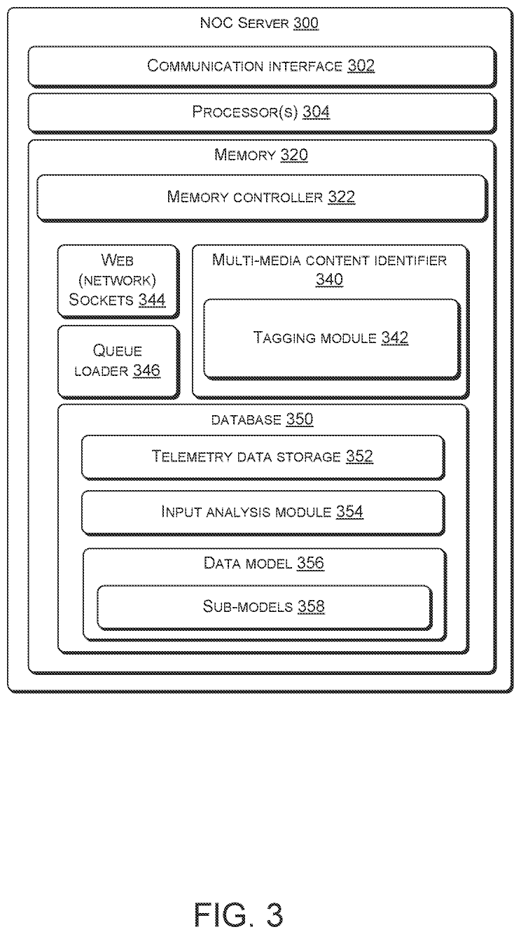

FIG. 3 is a diagram of an example NOC server 300 with a multi-media content identifier in accordance with at least one embodiment. The output of the sub-models may be aggregated to generate an analysis request response such as inferring the safety of a law enforcement officer. The NOC server 300, which is similar to the NOC server 104 of FIG. 1, may include a computer system that implements deployment of the media recording devices to capture telemetry data that can be tagged and associated with searchable contents to improve audio content searching in a large amount of content data as described herein.

The NOC server 300 includes a communication interface 302 that facilitates communication with the media recording devices such as the media recording devices 102(1)-102(N). Communication between the NOC server 300 and other electronic devices may utilize any sort of communication protocol known in the art for sending and receiving data and/or voice communications.

The NOC server 300 includes a processor 304 having electronic circuitry that executes instruction code segments by performing basic arithmetic, logical, control, memory, and input/output (I/O) operations specified by the instruction code. The processor 304 can be a product that is commercially available through companies such as Intel® or AMD®, or it can be one that is customized to work with and control a particular system. The processor 304 may be coupled to other hardware components used to carry out device operations. The other hardware components may include one or more user interface hardware components not shown individually—such as a keyboard, a mouse, a display, a microphone, a camera, and/or the like—that support user interaction with the NOC server 300.

The NOC server 300 also includes memory 320 that stores data, executable instructions, modules, components, data structures, etc. The memory 320 may be implemented using computer-readable media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc—Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by modulated data signals, such as a carrier wave. In contrast, communication media may embody computer-readable instructions, data structures, program modules, or other data in a modulated data signal, such as a carrier wave, or other transmission mechanisms.

A memory controller 322 may be stored in the memory 320 of the NOC server 300. The memory controller 322 may include hardware, software, or a combination thereof, that enables the memory 320 to interact with the communication interface 302, processor 304, and other components of the NOC server 300. For example, the memory controller 322 receives telemetry data streams (e.g., audio and video contents) from the communication interface 302 and facilitates storing of the received telemetry data streams in the memory 320. In another example, the memory controller 322 may retrieve data streams from memory 320 and the retrieved data streams can be processed in the processor 304.

The memory 320 includes the multi-media content identifier 340 that, when executed, implements selecting of the sub-models to execute to identify a particular audio content without actually controlling the continuity of the decoupled telemetry data streams from the event streaming platform. The multi-media content identifier 340 may further include a tagging module 342 that can associate searchable contents to identified audio contents, for example. Each type of searchable content may be associated with a sub-model that can be used to identify the particular audio content.

The memory 320 may further store and/or implement, at least in part, web-sockets 344, a queue loader 346, and a database 350. The database 350 may further include a telemetry data storage 352, an input analysis module 354, and a data model 356 with sub-models 358. In one example, each component of the memory 320 can be realized in hardware, software, or a combination thereof.

The web-sockets 344 may be similar to the web-sockets 108(1)-108(N) of FIG. 1. The web-sockets 344 may be implemented by a software module designed to establish communications with the media recording devices 102(1)-102(N), respectively. In one example, each one of the web-sockets 108(1)-108(N) is bound to the IP address and the port number to communicate with the corresponding media recording device.

In one example, the queue loader 346 may include an application programming interface (API) to establish a connection with the event streaming platform. The event streaming platform may utilize logs to store the telemetry data streams from the media recording devices. The logs are immutable records of things or events. The logs may include topics and partitions to store the telemetry data streams. In one example, the multi-media content identifier 340 of the NOC server 300 may subscribe to audio content in the event streaming platform and utilize the queue loader 346 to decouple the telemetry data streams that the multi-media content identifier 340 has subscribed to receive. The decoupled telemetry data streams (audio contents) are stored in the telemetry data storage 352. In another example, the multi-media content identifier 340 may subscribe to receive the video contents. Similarly, the multi-media content identifier 340 may use the queue loader 346 to decouple the telemetry data streams (video contents) without disturbing continuity of received telemetry data streams from the multi-media devices or sources.

The telemetry data storage 352 may store the decoupled telemetry data streams from the queue loader 346. In one example, the decoupled telemetry data streams may include audio contents, video contents, or a combination thereof, from a particular one or more media recording devices 102. For example, the decoupled telemetry data streams may be associated with a particular dispatch event, law enforcement officer, law enforcement vehicle, or a combination thereof. In this example, the decoupled telemetry data streams may include device ID, law enforcement officer ID or rank, vehicle ID, and the like. The information associated with the stored telemetry data streams may be used as additional parameters of the searchable content. For example, the searchable content may include the name of the law enforcement officer during a particular dispatch event, the media recording devices that were present during the dispatch event, recorded gunshots if any, and recorded sounds after a certain phrase such as “DO NOT MOVE” or “HELP,” and the like.

Input analysis module 354 may parse the user input from a user device. The user input may include the environmental data such as the real-time audio data and real-time visual data captured by the user device. The user input may also include an analysis request that can be used by the input analysis module 354 to select the data model that can further include a plurality of sub-models where the output of the sub-models may be aggregated to infer, for example, the attending officer's safety during the dispatch event.

Data model 356 may be formed by sub-models that can be used to identify different types of audio content. Each sub-model may further include corresponding attributes or features when categorizing the telemetry data streams. For example, the sub-model for detecting a gunshot sound may include attributes such as the level of sound detected by different sensors in the vicinity of the gunshot, the presence of alternating loud sound indicating possible different firearms, a sound of gun reloading, type of dispatch event, time and day of the year, or criminal history of the person associated with the dispatch event. In this example, few or all of these attributes may be utilized to predict the presence of the gunshot in the telemetry data streams.

In another example, the sub-model for detecting the firecracker sound may include attributes such as the time when a holiday or event is celebrated and firecrackers are commonly used, the frequency of different spikes in sounds, the presence of regular conversation or laughter, or the lack of keywords that infer violence such as “DO NOT MOVE.” In this example, few or all of these attributes may be utilized to predict the presence of the firecracker in the telemetry data streams.

In another example, the sub-model for detecting the motive of the apprehended person may include shouting of keywords such as “COPS,” “RUN,” etc. Other attributes for detecting motive may also include the type of dispatch event, the history of the person to be apprehended, the time of day, the statement of possible “DUI” by the officer, and the like.

In the above examples, the sub-models may be aggregated to infer the safety of the law enforcement officer. Alternatively, or in addition, each output of the sub-model may be used as a reference for tagging the corresponding telemetry data streams for future references. ?For example, when surrounding facts of a particular event e.g., resulting homicide is currently the subject of investigation. Consider a law enforcement officer who is attending an event where the sound of a gunshot, a screeching vehicle, and the shouting of specific phrases such as “STOP” can be detected in real-time at the NOC server 300. In this case, the NOC server 300 may transmit a warning in real-time to the law enforcement officer. Further, the NOC server 300 may tag the telemetry data streams by associating searchable contents to improve multi-media content searching over a complex and large amount of telemetry data streams that can be received from thousands or millions of multi-media devices.

Further functionalities of the NOC server 300 and its component features are described in greater detail, below.

### Example Data Table of Sub Models

FIG. 4 is a block diagram of data example data table 400 showing sub-models and corresponding attributes that can be used in a machine-learning algorithm to implement the tagging and associating of the searchable contents to the telemetry data streams. The data table 400 further shows the data model 410 that can be formed from aggregated sub-models to infer, for example, the safety of the law enforcement officer during the dispatch event. The attributes of the data model may include the output of some or all of the sub-models as well as combinations and transformations thereof.

As shown, the data table 400 may include data model 410 that may be formed by aggregating first sub-model 412, second sub-model 414, third sub-model 416, and a fourth sub-model 418. The data table 400 further shows attributes 440 and output 460. In accordance with at least one embodiment, each of the sub-models may be used to identify audio contents, video contents, or a combination thereof, in the telemetry data streams.

For example, the first sub-model 412 may be trained on samples of telemetry data streams to identify a gunshot. In this example, a first set of attributes 442 for the first sub-model 412 may include frequency of detected spike in sounds, time of the day, day of the year, type of dispatch event, name of individual, background of identified individual as supplied by attending law enforcement officer, and the like. The NOC server, via the multi-media content identifier, may then utilize a threshold (not shown) to generate a first output 462. For example, the first output 462 may generate a likelihood that a gunshot occurred in the new sample of telemetry data streams.

In another example, the second sub-model 414 may be trained on samples of telemetry data streams to identify a presence of a distressed person. In this example, a second set of attributes 444 for the second sub-model 414 may include time of the day, day of the year, type of dispatch event, name of an individual, background of identified individual as supplied by attending law enforcement officer, detected words or phrases such as “HELP,” presence of a call to a medic officer, and the like. The NOC server, via the multi-media content identifier, may then utilize a different threshold (not shown) to generate a second output 464. For example, the second output 464 may generate a likelihood that a distressed person is present in the dispatch event environment.

In another example, the third sub-model 416 may be trained on samples of telemetry data streams to identify a sound of a firecracker. In this example, a third set of attributes 446 for the third sub-model 416 may include time of the day, day of the year if it's a fourth of July event, type of dispatch event, name of an individual, background of identified individual as supplied by attending law enforcement officer, detected words or phrases such as “WOW,” and the like. The NOC server, via the multi-media content identifier, may then utilize a different threshold (not shown) to generate a third output 466. For example, the third output 466 may generate a likelihood that a firecracker sound is detected in the samples of telemetry data streams.

In another example, the fourth sub-model 418 may be trained on samples of telemetry data streams to identify a presence of scuffling between individuals. In this example, a fourth set of attributes 448 for the fourth sub-model 418 may include time of the day, day of the year, type of dispatch event, name of an individual, background of identified individual as supplied by attending law enforcement officer, detected words or phrases such as “AHHH . . . UGGHHH,” presence of a call to a medic officer, volume of sounds that resembles a punch, and the like. The NOC server, via the multi-media content identifier, may then utilize a different threshold (not shown) to generate a fourth output 468. For example, the fourth output 468 may generate a likelihood that a scuffling between individuals is present in the dispatch event environment.

In accordance with at least one embodiment, the data model 410 may be formed from aggregated sub-models. In this embodiment, data model attributes 450 of the data model 410 may include outputs and/or attributes 440 of the sub-models. Further, a data model output 470 may infer the safety of the law enforcement officer who is attending the dispatch event. Accordingly, the output 460 may not only be used to tag and associate searchable contents to the samples of telemetry data streams, but the output 460 may also be utilized by the data model 420 to send a warning in real-time to the law enforcement officer in the dispatch event.

### Example Implementation—Tagging of Telemetry Data Streams

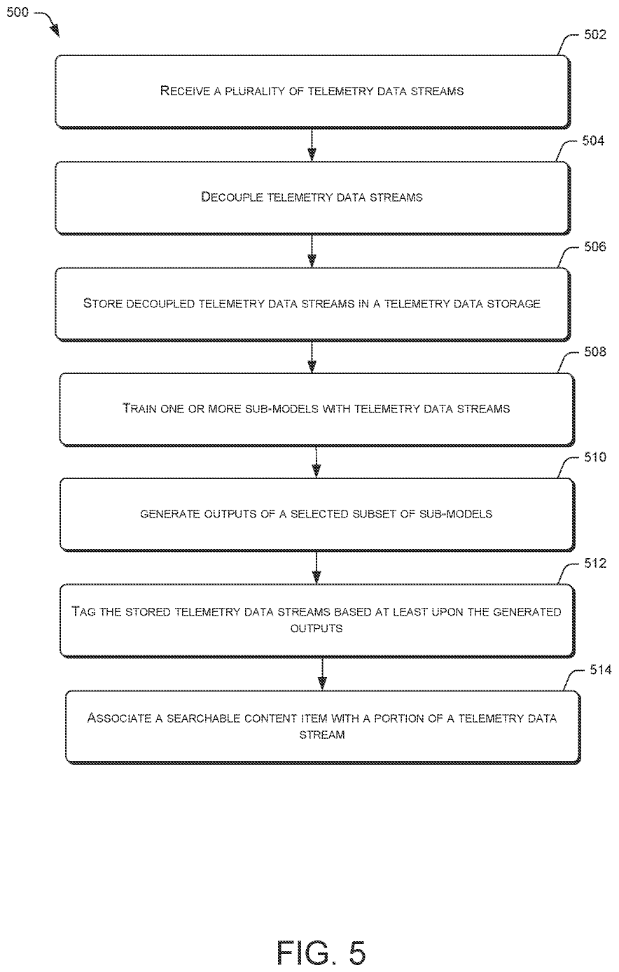

FIG. 5 is a flow diagram 500 that depicts an example process for at least one aspect of the techniques for implementing the tagging and associating of the searchable contents to the telemetry data streams. In the following discussion of FIG. 5, continuing reference is made to the elements and reference numerals shown in and described with respect to the NOC server of FIGS. 1 and 3. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 502, the NOC server 300 may receive a plurality of telemetry data streams from the media recording devices 102. In one example, the queue 110 includes an event streaming platform that receives data packet streams encoded in JSON, XML, or other structured data modeling language. The data packet streams, for example, include audio content, video content, metadata, virtual reality or augmented reality data, and information that may be captured by the media recording devices 102.

At block 504, the NOC 300 may decouple the telemetry data streams for storing in the telemetry data storage. For example, the telemetry data streams from a group of media recording devices 102 that are associated with a particular dispatch event may be extracted from the plurality of telemetry data streams in the queue 110 and stored in the telemetry data storage. In another example, the telemetry data components that include audio contents from a particular media and uploaded on a particular timestamp or date may be stored in the telemetry data storage. In these examples, the extracted or decoupled telemetry data streams may be associated with source device IDs, timestamp, event IDs, header, sensor format, and key-value annotations. The fields of the decoupled telemetry data streams may be identified and stored to conform with a structure of a universal schema.

At block 506, the telemetry data storage 352 may store decoupled telemetry data streams. In one example, the telemetry data storage may receive the decoupled telemetry data streams that it subscribed to. In this example, the processing of the decoupled telemetry data streams may be implemented without affecting the continuity of the receiving of telemetry data streams in the event streaming platform.

At block 508, the NOC server 300, via the multi-media content identifier, may train one or more sub-models to the stored telemetry data streams. In one example, each of the sub-models may be trained to detect presence of a particular audio content, video content, or a combination of both. For example, the particular audio content may include sound of gunshot, firecracker, and the like. In accordance with at least one embodiment, training of sub-models may be performed independent of and/or substantially in advance of detection operations such as those of block 510. For example, gunshot sound ML models may be retrained on an annual basis, while gunshot detection with the trained model may be performed daily.

At block 510, the multi-media content identifier 340 may generate outputs of a selected subset of sub-models. In accordance with at least one embodiment, each sub-model may be associated with corresponding threshold. For example, the sub-model for detecting a gunshot sound may include a threshold that can be used to determine the likelihood of detecting the gunshot. In another example, the sub-model for detecting a firecracker sound may include a threshold that can be used to determine the likelihood of detecting the sound of the firecracker, and so on. Alternatively, some or all sub-models may utilize an ML model to output an indication selected from the set “detected” or “not detected.” Some sub-models may further select from a set including an “ambiguous” indication.

At block 512, the multi-media content identifier 340 may tag the stored telemetry data streams based at least upon the output of a selected subset of the sub-models.

At block 514, the multi-media content identifier 340 may associate a searchable content item with a portion of a telemetry data stream. In one example, the searchable content may include a phrase such as “gunshot,” a sound of an object such as a car screeching, or a human reaction such as a person shouting or in distress.

### Example Implementation—Aggregating Sub-Models

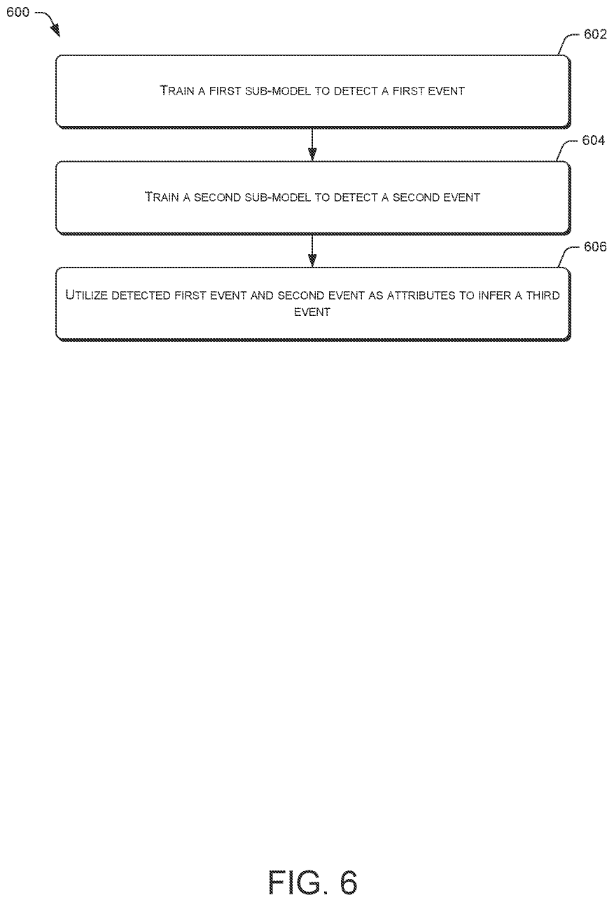

FIG. 6 is a flow diagram 600 that depicts an example procedure for at least one aspect of the techniques for aggregating sub-model outputs to generate an output that includes inferring the safety of the law enforcement officer during the dispatch event, in accordance with at least one embodiment. In the following discussion of FIG. 6, continuing reference is made to the elements and reference numerals shown in and described with respect to the NOC server of FIGS. 1 and 3. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 602, the multi-media content identifier 340 may train a first sub-model to a set of telemetry data streams to detect a first event. For example, the first sub-model may be trained to detect a gunshot. In this example, the first event may include the presence or absence of a detected gunshot.

At block 604, multi-media content identifier 340 may train a second sub-model to the set of telemetry data streams to detect a second event. For example, the second sub-model may be trained to detect a hostile environment. Attributes of the hostile environment may include the type of the dispatch event, the presence of shouting, the detection of key phrases such as curse words, the exchange of curses, and the like. In this example, the second event may include presence or absence of a hostile environment.

In accordance with at least one embodiment, the multi-media content identifier 340 may train the first and second sub-models in parallel.

At block 606, the multi-media content identifier 340 may utilize the output of the first sub-model and the second sub-model as attributes to infer a third event. For example, the multi-media content identifier may train ML model on the first event, second event, and other attributes to infer (e.g., indicate, score and/or rank) the presence of imminent danger to the law enforcement officer during the dispatch event. In this example, the first sub-model and the second sub-model may be executed in parallel to improve the processing of the telemetry data streams.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more computer-readable storage media collectively storing computer-executable instructions that upon execution cause one or more computers to collectively perform acts comprising:
receiving, by an event streaming platform, a plurality of telemetry data streams from a plurality of multi-media devices;
storing, by a telemetry data storage, decoupled telemetry data streams based at least in part on the plurality of telemetry data streams;
training, by a multi-media content identifier, one or more sub-models based at least in part on stored telemetry data streams that are associated with one or more audio content types;
generating, by the multi-media content identifier, one or more outputs of the trained sub-models based at least in part on a telemetry data stream;
tagging the telemetry data stream based at least upon the generated outputs; and
associating a searchable content item with a portion of the telemetry data stream based at least in part on the tagging.

2. The one or more computer-readable storage media of claim 1, wherein the decoupled telemetry data streams include audio and video contents that were subscribed to be received and stored in the telemetry data storage and without affecting continuity of the receiving of the plurality of telemetry data streams from the multi-media devices.

3. The one or more computer-readable storage media of claim 1, wherein the training includes training in parallel the sub-models to the stored telemetry data streams.

4. The one or more computer-readable storage media of claim 1, wherein at least some of the sub-models utilize different attributes to detect an audio content.

5. The one or more computer-readable storage media of claim 4, wherein a detected audio content includes a sound of a gunshot.

6. The one or more computer-readable storage media of claim 5, wherein the attributes utilized to detect the sound of the gunshot include at least one of: a type of the dispatch event, time of day, or volume of detected sound.

7. The one or more computer-readable storage media of claim 4, wherein a detected audio content includes a sound of a firecracker.

8. The one or more computer-readable storage media of claim 1, wherein the searchable content includes a phrase, sound of an object, or a human reaction.

9. The one or more computer-readable storage media of claim 1, wherein the sub-models are combined to generate a data model.

10. The one or more computer-readable storage media of claim 1, wherein the tagging the telemetry data stream includes tagging different timestamps in the telemetry data stream to be associated with the searchable content item.

11. A computer implemented method, comprising:
receiving a plurality of telemetry data streams from a plurality of multi-media devices;
training one or more sub-models based at least in part on one or more of the plurality of telemetry data streams that are associated with one or more audio content types;
generating one or more outputs of the trained sub-models based at least in part on a telemetry data stream;
tagging the telemetry data stream based at least upon the generated outputs; and
associating a searchable content item with a portion of the telemetry data stream based at least in part on the tagging.

12. The computer implemented method of claim 11, wherein at least some of the plurality of telemetry data streams include audio and video contents that were subscribed to be received and stored in a telemetry data storage without affecting continuity of the receiving of the plurality of telemetry data streams from the multi-media devices.

13. The computer implemented method of claim 11, wherein the training includes training in parallel the sub-models based at least in part on the plurality of telemetry data streams.

14. The computer implemented method of claim 11, wherein at least some of the sub-models utilize different attributes to detect different types of audio content.

15. The computer implemented method of claim 14, wherein a detected audio content item includes a sound of a gunshot.

16. The computer implemented method of claim 15, wherein the attributes utilized to detect the sound of the gunshot include at least one of: a type of the dispatch event, time of day, or volume of detected sound.

17. The computer implemented method of claim 14, wherein a detected audio content includes a sound of a firecracker.

18. A computer system, comprising:
one or more processors; and
memory including a plurality of computer-executable instructions that are executable by the one or more processors to perform a plurality of actions, the plurality of actions comprising:
training one or more sub-models based at least in part on one or more telemetry data streams that are associated with one or more audio content types;
generating one or more outputs of the trained sub-models based at least in part on a telemetry data stream;
tagging the telemetry data stream based at least upon the generated outputs; and
associating a searchable content item with a portion of the telemetry data stream based at least in part on the tagging.

19. The computer system of claim 18, wherein the one or more telemetry data streams include audio and video contents that were subscribed to be received and stored in a telemetry data storage and without affecting continuity of the receiving of the one or more telemetry data streams.

20. The computer system of claim 18, wherein the training includes training the one or more sub-models in parallel with receiving the one or more telemetry data streams.
